(19) United States
(12) Patent Application Publication
(10) Pub. No.: US 2024/0081293 A1
(43) Pub. Date: Mar. 14, 2024

(54) APPARATUS FOR MONITORING THE BIOLOGICAL CONDITION OF PREGNANT BREEDING CATTLE

(71) Applicant: DICSVISION CO., LTD., JEOLLABUK-DO (KR)

(72) Inventors: Sang Hyon PAK, Jeollabuk-do (KR); Gil Yang PARK, Jeollabuk-do (KR); Won Yup PARK, Jeollabuk-do (KR); Woo Young CHOI, Jeollabuk-do (KR)

(21) Appl. No.: 18/089,088

(22) Filed: Dec. 27, 2022

(30) Foreign Application Priority Data
Sep. 8, 2022 (KR) 10-2022-0114345

(51) Int. Cl. A01K 29/00; A61D 17/00; G06N 5/022

(52) U.S. Cl. CPC A01K 29/005; A61D 17/002; A61D 17/008; G06N 5/022

(57) ABSTRACT

An apparatus for monitoring a biological condition of pregnant breeding cattle includes a training data collection unit to select and use at least two of an implantable device, a wearable device or an imaging device as a training data collection device to create multiple training data, a prediction model training unit to pre-train a prediction model through the multiple training data, a device cooperation cases setting unit to decide and store device cooperation cases by collecting and analyzing sensing data acquired through the training data collection devices, a device cooperation conducting unit to preprocess the sensing data of a monitoring device according to the device cooperation cases when at least one of the training data collection devices is selected as the monitoring device, and a biological condition prediction unit to predict and output a biological condition corresponding to the sensing data preprocessed through the prediction model.

### CROSS-REFERENCE TO RELATED APPLICATION AND CLAIM OF PRIORITY

This application claims the benefit under 35 USC § 119 of Korean Patent Application No. 10-2022-0114345, filed on Sep. 8, 2022, in the Korea Intellectual Property Office, the entire disclosure of which is incorporated herein by reference for all purposes.

### BACKGROUND

### 1. Field

The present disclosure relates to an apparatus for monitoring biological conditions of pregnant breeding cattle with improved accuracy and efficiency.

### 2 Description of the Related Art

Currently, the livestock sector urgently needs to improve the work environment and cost competitiveness as well as productivity and reliability of livestock products through scientific breeding management.

In particular, there is a growing need for systems for detecting changes in estrus, parturition, disease symptoms, body temperature and activity level with changes in breeding environment, and providing information to farmers through real-time notification.

In this circumstance, developed countries in the livestock sector such as Germany, USA, Israel and Japan have developed and provided real-time livestock condition monitoring technology using biological information collection devices in the form of ear tag type sensors, collar type sensors and ankle-worn sensors, but these devices are sold at very high costs, and a very passive attitude is taken to send data acquired in other countries back to home country, build the data as assets and share information.

Additionally, localization is necessary to improve the spread of smart farming to domestic livestock farms and collect domestic bigdata, and there is a need for the combination and convergence of technologies for efficient management of the biological environment of livestock by the adoption of ICT, IoT, bigdata, artificial intelligence and automation system in sheds.

### SUMMARY

The present disclosure is designed to solve the above-described problem, and therefore the present disclosure is directed to providing an apparatus for monitoring biological conditions of pregnant breeding cattle with improved accuracy and efficiency.

The objective of the present disclosure is not limited to the above-mentioned objective, and these and other objectives will be clearly understood by those skilled in the art from the following description.

To solve the above-described problem, according to an embodiment of the present disclosure, there is provided an apparatus for monitoring biological conditions of pregnant breeding cattle including a training data collection unit to select and use at least two of an implantable device, a wearable device or an imaging device as a training data collection device to create multiple training data; a prediction model training unit to pre-train a prediction model through the multiple training data; a device cooperation cases setting unit to decide and store device cooperation cases by collecting and analyzing sensing data acquired through the training data collection devices; a device cooperation conducting unit to preprocess the sensing data of a monitoring device according to the device cooperation cases when at least one of the training data collection devices is selected as the monitoring device; and a biological condition prediction unit to predict and output a biological condition corresponding to the sensing data preprocessed through the prediction model, wherein the prediction model has at least one of activity level, temperature, pressure, pulse, activity type, location information or Stage 1 rupture time point as an input condition and at least one of an estrus index, a parturition index or a health index as an output condition.

When data of a same item is redundantly acquired by the at least two training data collection devices, the training data collection unit acquires the data of the device having highest sensitivity to a condition change of the pregnant breeding cattle as an item representative value, and uses the acquired item representative value as the input condition of the train data.

In case that the implantable device and the wearable device are used as the training data collection device, and any one of the implantable device and the wearable device is used as the monitoring device, the device cooperation cases define activity level verification using a pulse sensor of the implantable device and an in vitro sensor of the wearable device, correction of a temperature change of the implantable device and an external sensor temperature change of the wearable device, correction of a pressure change of the implantable device and an external sensor pressure change of the wearable device, and detection and training of a change in activity level using a Stage 1 rupture time point value of the implantable device and the in vitro sensor of the wearable device.

In case that the implantable device and the imaging device are used as the training data collection device, and any one of the implantable device and the imaging device is used as the monitoring device, the device cooperation cases define activity level verification using a pulse sensor of the implantable device and the imaging device, detection and training of a Stage 1 rupture time point value of the implantable device and a change in activity level using the imaging device, and verification of labor and estrus behavior using the imaging device and a change of in the vivo sensor of the implantable device.

In case that the implantable device and the wearable device are used as the training data collection device and any one of the implantable device and the wearable device is used as the monitoring device, the device cooperation cases define activity level verification using a pulse sensor of the implantable device and an in vitro sensor of the wearable device, correction of a temperature change of the implantable device and an external sensor temperature change of the wearable device, correction of a pressure change of the implantable device and an external sensor pressure change of the wearable device, and detection and training of the Stage 1 rupture time point value of the implantable device and a change in activity level using the in vitro sensor of the wearable device.

In case that the implantable device and the imaging device are used as the training data collection device, and any one of the implantable device and the imaging device is used as the monitoring device, the device cooperation cases define activity level verification using a pulse sensor of the implantable device and the imaging device, detection and training of a Stage 1 rupture time point value of the implantable device and a change in activity level using the imaging device, and verification of labor and estrus behavior using the imaging device and a change of the in vivo sensor of the implantable device.

In case that the wearable device and the imaging device are used as the training data collection device, and any one of the wearable device and the imaging device is used as the monitoring device, the device cooperation cases define verification of labor and estrus behavior using the imaging device and a change of the in vitro sensor of the wearable device.

In case that the implantable device, the wearable device and the imaging device are used as the training data collection device, and at least one of the implantable device, the wearable device or the imaging device is used as the monitoring device, the device cooperation cases define correction of an actual behavior in the imaging device through an external sensor pressure change of the wearable device based on an in vivo pressure change of the implantable device, correction of accurate Stage 1 rupture time point of the wearable device through the Stage 1 rupture time point value of the implantable device and verification through the imaging device, verification of the labor and estrus behavior monitored by the imaging device and a change of the in vivo sensor of the implantable device and the in vitro sensor of the wearable device, correction of the activity level information of the in vivo activity sensor of the implantable device and the in vitro activity sensor of the wearable device and the activity type and activity level in an input image of the imaging device, data correction of the in vitro change of the wearable device based on the in vivo change of the implantable device and training of the imaging device with the activity type and activity level, correction of the imaging device with regard to the labor and estrus detected by the change of the in vivo sensor of the implantable device and the in vitro sensor of the wearable device and correction of the results, cross correction of the activity level of the in vivo activity sensor of the implantable device after activity level analysis and correction of the in vitro activity sensor of the wearable device and the imaging device, clustering correction of a candidate result group of analysis results of the in vitro change of the wearable device into the change of the in vivo sensor of the implantable device by analysis of a relationship with the activity level through the imaging device, training of the in vivo sensor change of the implantable device based on the in vitro sensor activity level information of the wearable device and the activity type verified by the imaging device, and training of the in vivo sensor change of the implantable device based on the in vitro sensor change of the wearable device and the labor and estrus detected by activity level analysis of the imaging device.

The device cooperation cases setting unit further includes a function to acquire sensing data based on another type of means which is any one of another type of device and another type of object, and additionally decide and store device cooperation cases for another type of means by comparative analysis with the sensing data acquired through the training data collection device.

The device cooperation conducting unit further includes a function to preprocess the sensing data of the monitoring device according to the device cooperation cases for another type of means in response to a biological condition monitoring request through any one of another type of device and another type of object.

To solve the above-described problem, according to another embodiment of the present disclosure, there is provided an apparatus for monitoring biological conditions of pregnant breeding cattle including a training data collection unit to select and use at least one of an implantable device, a wearable device or an imaging device as a training data collection device to create multiple training data; a prediction model training unit to pre-train a prediction model through the multiple training data; a device cooperation cases setting unit to acquire sensing data based on another type of means which is any one of another type of device and another type of object, and decide and store device cooperation cases for another type of means by comparative analysis with the sensing data acquired through the training data collection device; a device cooperation conducting unit to preprocess the sensing data of another type of device using the device cooperation cases for another type of means; and a biological condition prediction unit to predict and output a biological condition corresponding to the sensing data preprocessed through the prediction model, wherein the prediction model has at least one of activity level, temperature, pressure, pulse, activity type, location information or Stage 1 rupture time point as an input condition and at least one of an estrus index, a parturition index or a health index as an output condition.

The present disclosure predicts and notifies the biological conditions of pregnant breeding cattle by training and using sensing data acquired through various types of sensing devices by deep learning, thereby maximizing the analysis accuracy at the minimized costs and efforts required to implement and maintain the system.

In addition, the present disclosure pre-trains the prediction model by the cooperative use of at least two sensing devices, and when the level of cooperation is adequate, acquires data necessary for the prediction operation with the minimum number of devices. Accordingly, it is possible to monitor and predict the conditions of pregnant breeding cattle with minimal external stimulus through the minimum number of sensing devices.

Additionally, the present disclosure provides the device cooperation function with other device than the sensing device used to train the prediction model together, thereby maximizing the application scalability of the system.

### BRIEF DESCRIPTION OF THE DRAWINGS

FIG. 1 is a diagram showing an apparatus for monitoring biological conditions of pregnant breeding cattle according to an embodiment of the present disclosure.

FIGS. 2 to 7 are diagrams illustrating a method for monitoring biological conditions of pregnant breeding cattle according to an embodiment of the present disclosure.

FIG. 8 is a diagram illustrating a method for monitoring biological conditions of pregnant breeding cattle according to another embodiment of the present disclosure.

### DETAILED DESCRIPTION OF THE EMBODIMENTS

Hereinafter, an exemplary embodiment will be described in sufficient detail with reference to the accompanying drawings for those skilled in the art to easily practice the present disclosure. However, in describing an exemplary embodiment of the present disclosure, when it is determined that a certain detailed description of relevant known functions or elements may unnecessarily obscure the subject matter of the present disclosure, the detailed description is omitted. Additionally, identical reference signs are used for the elements having similar functions and operations throughout the drawings.

In addition, throughout the specification, when an element is referred to as being ‘connected to’ another element, it can be directly connected to the other element or intervening elements may be present. Additionally, unless the context clearly indicates otherwise, the term ‘comprises’ when used in this specification, specifies the presence of stated elements, but does not preclude the presence or addition of one or more other elements.

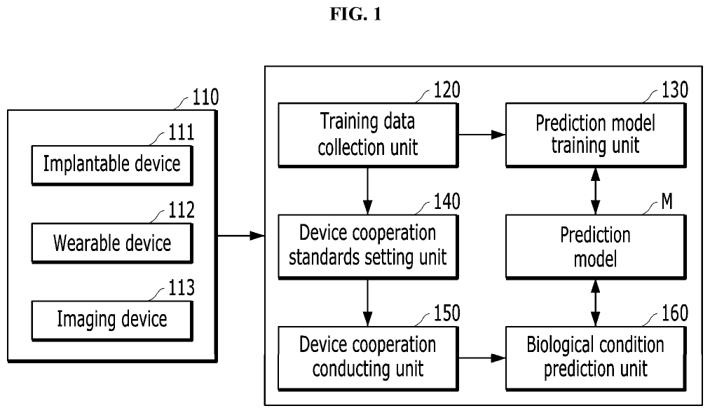

FIG. 1 is a diagram showing an apparatus for monitoring biological conditions of pregnant breeding cattle according to an embodiment of the present disclosure.

As shown in FIG. 1, the apparatus 100 of the present disclosure includes a sensing device 110 including an implantable device 111, a wearable device 112 and an imaging device 113, a training data collection unit 120 to select and use at least two of the implantable device 111, the wearable device 112 or the imaging device 113 as a training data collection device to create multiple training data, a prediction model training unit 130 to pre-train a prediction model through the multiple training data, a device cooperation cases setting unit 140 to decide and store device cooperation cases by collecting and analyzing sensing data acquired through the training data collection device, a device cooperation conducting unit 150 to preprocess the sensing data of a monitoring device according to the device cooperation cases when at least one of the training data collection devices is selected as the monitoring device, and a biological condition prediction unit 160 to predict and output a biological condition corresponding to the preprocessed sensing data through the prediction model.

As described above, the present disclosure pre-trains the prediction model through at least two sensing devices, and when the prediction model is adequately trained, performs the operation of monitoring the biological condition of the pregnant breeding cattle using at least one sensing device (i.e., a minimum number of sensing devices).

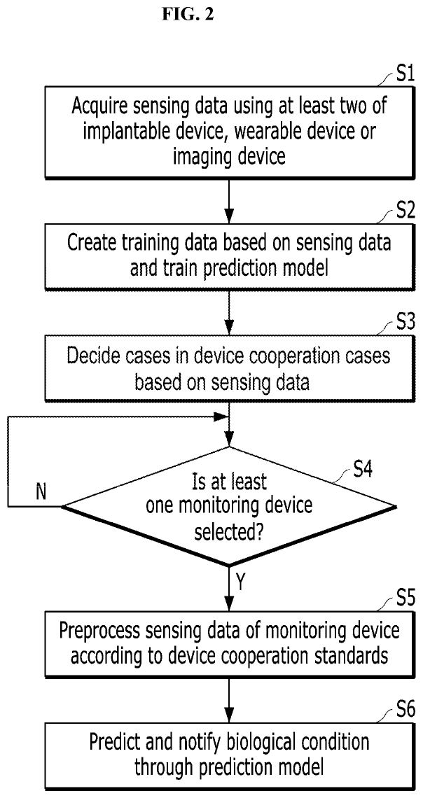

FIGS. 2 to 7 are diagrams illustrating a method for monitoring biological conditions of pregnant breeding cattle according to an embodiment of the present disclosure.

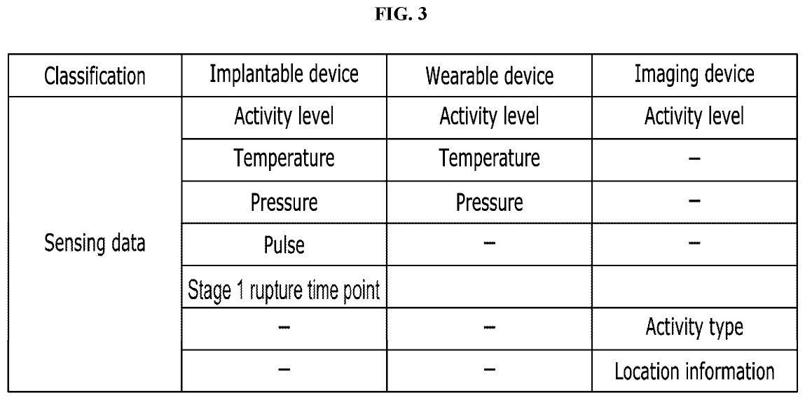

In step S1, the plurality of sensing devices 110 includes the implantable device 111, the wearable device 112 and the imaging device 113 to acquire and provide various types of sensing data of the pregnant breeding cattle as shown in FIG. 3.

The implantable device 111 includes an activity sensor (or a motion sensor), a temperature sensor, a pressure sensor and a pulse sensor implanted in the body (for example, cervix, stomach, etc.) of the pregnant breeding cattle, and senses and outputs information associated with in vivo activity level, in vivo temperature, in vivo pressure, pulse and Stage 1 rupture time point through the sensors.

The wearable device 112 includes an activity sensor, a temperature sensor and a pressure sensor attached to the body (for example, the back of neck, ankle, ear, etc.) of the pregnant breeding cattle, and senses and outputs information associated with in vitro activity level, in vivo temperature and in vivo pressure through the sensors.

The imaging device 113 is installed in the shed of the pregnant breeding cattle to image and analyze the pregnant breeding cattle and acquire and output information associated with activity level, activity type (for example, feed intake, sleeping, mounting, lying, standing, etc.) and location information.

In step S2, the training data collection unit 120 selects at least two of the plurality of sensing devices 110 as the training data collection device under a user's consent, and collects and analyzes the sensing data through the training data collection devices to create multiple training data.

In this instance, the data of the same item may be redundantly acquired by the at least two training data collection devices, and in this case, the data of the device having the highest sensitivity to a condition change of the pregnant breeding cattle is selected and used as an item representative value.

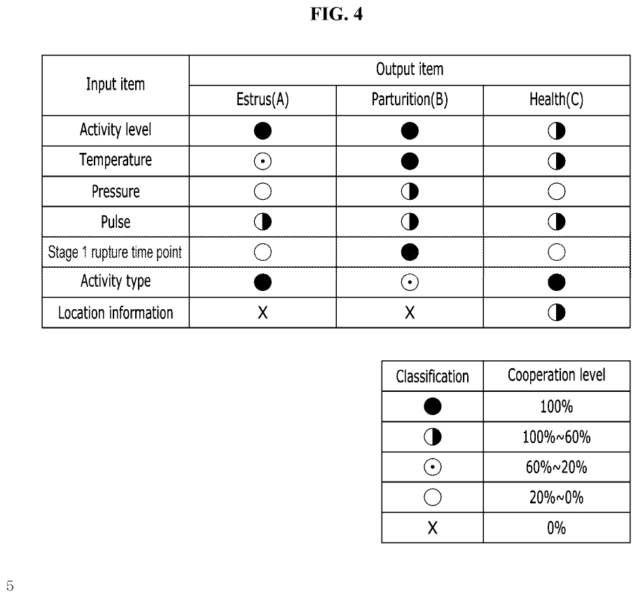

Accordingly, as shown in FIG. 4, the present disclosure collects the sensing data acquired through the at least two training data collection devices for each item, and acquires the activity level, temperature, pressure, pulse, activity type, location information and Stage 1 rupture time point as the representative value for each item. Additionally, the present disclosure creates multiple training data having at least one of the representative values for each item as an input condition and at least one of an estrus index, a parturition index or a health index as an output condition.

The prediction model training unit 130 may pre-train the prediction model M by deep learning through the multiple training data created through the training data collection unit 120 to enable the trained prediction model M to predict the biological condition (i.e., at least one of the estrus index, the parturition index or the health index) corresponding to the sensing data including at least one of the activity level, temperature, pressure, pulse, activity type, location information or Stage 1 rupture time point.

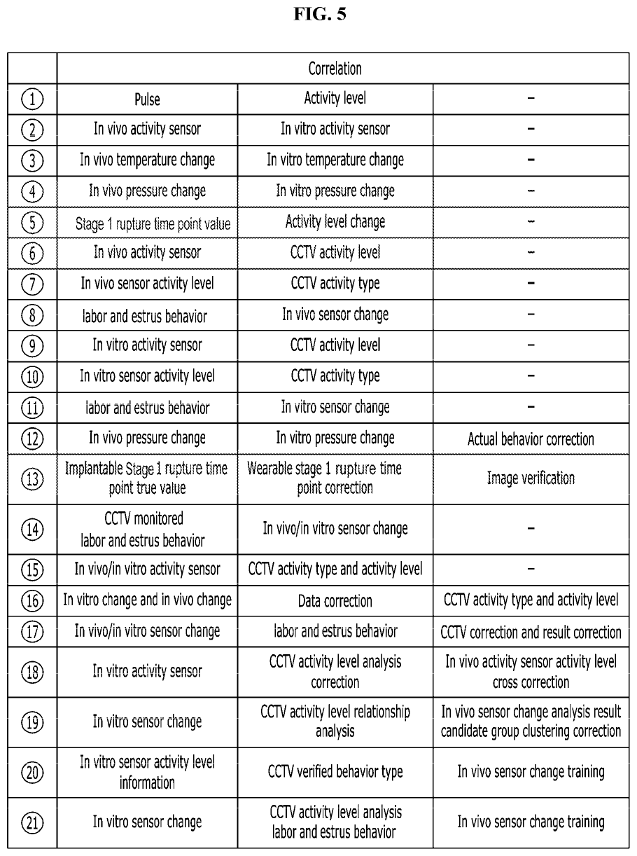

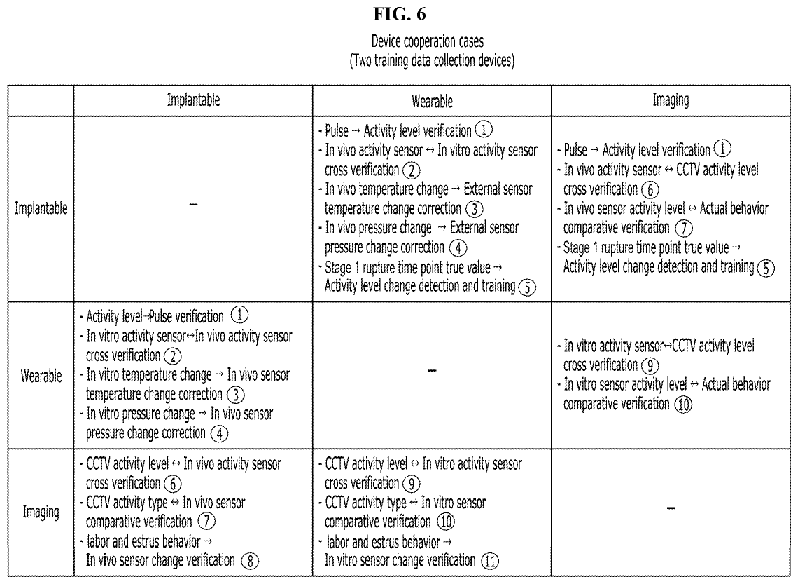

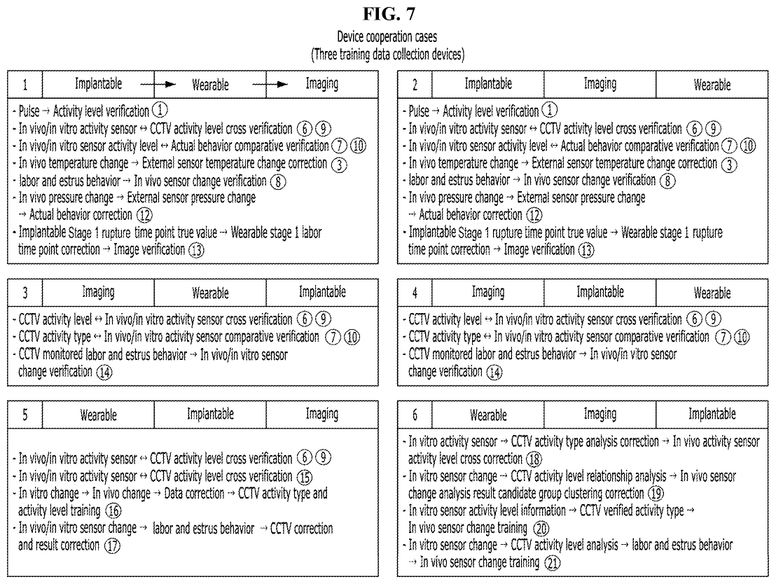

In step S3, the device cooperation cases setting unit 140 determines a correlation between the sensing data as shown in FIG. 5 by collecting and analyzing the sensing data acquired through the training data collection devices together with the step S2, and decides and stores the device cooperation cases as shown in FIGS. 6 and 7 based on the correlation.

In this instance, the device cooperation cases may be sub-classified and defined according to the type and number of training data collection devices and monitoring devices.

For example, (1) after the implantable device and the wearable device are used as the training data collection device, when one of them is used as the monitoring device, the device cooperation cases define activity level verification using the pulse sensor of the implantable device and the in vitro sensor of the wearable device, correction of a temperature change of the implantable device and an external sensor temperature change of the wearable device, correction of a pressure change of the implantable device and an external sensor pressure change of the wearable device, and detection and training of a change in activity level using the Stage 1 rupture time point value of the implantable device and the in vitro sensor of the wearable device.

Additionally, (2) after the implantable device and the imaging device are used as the training data collection device, when one of them is used as the monitoring device, the device cooperation cases define activity level verification using the pulse sensor of the implantable device and the imaging device, detection and training of a change in activity level using the Stage 1 rupture time point value of the implantable device and the imaging device, and verification of labor and estrus behavior using the imaging device and a change of the in vivo sensor of the implantable device.

Additionally, (3) after the wearable device and the imaging device are used as the training data collection device, when one of them is used as the monitoring device, the device cooperation cases define parturition and estrus prediction of pregnant breeding cattle by verifying the labor and estrus behavior using the imaging device and a change of the in vitro sensor of the wearable device.

Finally, (4) after the implantable device, the wearable device and the imaging device are used as the training data collection device, when at least one of them is used as the monitoring device, the device cooperation cases define correction of the actual behavior in the imaging device through a change in external sensor pressure of the wearable device based on a change in the in vivo pressure of the implantable device, correction of accurate Stage 1 rupture time point of the wearable device through the Stage 1 rupture time point value of the implantable device and verification through the imaging device, verification of the labor and estrus behavior monitored by the imaging device and a change in the in vivo sensor of the implantable device and the in vitro sensor of the wearable device, correction of the activity level information of the in vivo activity sensor of the implantable device and the in vitro activity sensor of the wearable device and the activity type and activity level in the input image of the imaging device, data correction of the in vitro change of the wearable device based on the in vivo change of the implantable device and training of the imaging device with the activity type and activity level, correction of the imaging device with regard to the labor and estrus detected by the change of the in vivo sensor of the implantable device and the in vitro sensor of the wearable device and correction of the results, cross correction of the activity level of the in vivo activity sensor of the implantable device after activity level analysis and correction of the in vitro activity sensor of the wearable device and the imaging device, clustering correction of a candidate result group of analysis results of the in vitro change of the wearable device into the change of the in vivo sensor of the implantable device by analysis of a relationship with the activity level through the imaging device, training of the in vivo sensor change of the implantable device based on the in vitro sensor activity level information of the wearable device and the activity type verified by the imaging device, and training of the in vivo sensor change of the implantable device based on the in vitro sensor change of the wearable device and the labor and estrus detected by activity level analysis of the imaging device.

In step S4, the device cooperation conducting unit 150 selects at least one sensing device of the training data collection devices as the monitoring device under the users consent.

In step S5, the device cooperation conducting unit 150 acquires the sensing data for monitoring the conditions of the pregnant breeding cattle using only the monitoring device.

Additionally, the preprocessing operation (i.e., verification, correction, training) is performed on the sensing data based on the device cooperation cases to replace the sensing data acquired using all the at least two training data collection devices with the sensing data acquired through the minimum number of monitoring devices.

In step S6, the biological condition prediction unit 160 inputs the sensing data preprocessed through the device cooperation conducting unit 150 to the prediction model M to enable the prediction model M to predict and output the biological conditions (i.e., at least one of the estrus index, the parturition index or the health index) corresponding to the sensing results of the monitoring device.

As described above, the present disclosure pre-trains the prediction model by the cooperative use of at least two sensing devices, and when the level of cooperation is adequate, acquires data necessary for the prediction operation with the minimum number of devices, and as a result, it is possible to monitor and predict the conditions of the pregnant breeding cattle with minimal external stimulus through the minimum number of sensing devices.

Additionally, it is most desirable to perform the prediction model training process individually for each pregnant breeding cattle to create and use a prediction model corresponding to each pregnant breeding cattle, but if necessary, the prediction model training process may be performed based on sensing data acquired through many pregnant breeding cattle to create and use a common prediction model universally applied to the pregnant breeding cattle.

In addition, the present disclosure enables another type device or object not used in the prediction model training process to perform the operation of predicting conditions of pregnant breeding cattle using the prediction model training results. That is, the present disclosure enables another type device or object to monitor and predict the conditions of pregnant breeding cattle corresponding to its sensing data by only the data handover process without the prediction model training process.

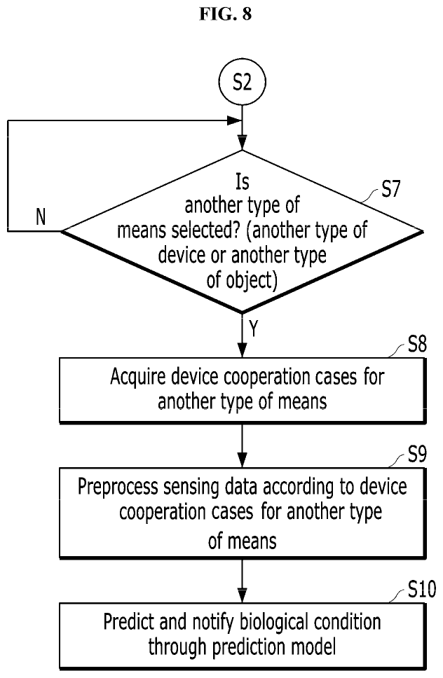

FIG. 8 illustrates a method for monitoring biological conditions of pregnant breeding cattle according to another embodiment of the present disclosure as below.

In step S7, the device cooperation conducting unit 150 determines if the biological condition monitoring operation based on another type of means has been requested. In this instance, another type of means may be any one of another type of device and another type of object, and another type of device refers to a sensing device not used to train the prediction model, and another type of object refers to pregnant breeding cattle not used to train the prediction model.

In step S8, the device cooperation conducting unit 150 determines a correlation between sensing data by the comparative analysis of sensing data acquired through another type of means and sensing data collected to create training data, and additionally decides and stores device cooperation cases for another type of means based on the correlation.

In step S9, after the device cooperation conducting unit 150 acquires the sensing data through another type of means, the device cooperation conducting unit 150 performs the preprocessing operation (i.e., verification, correction, training) on the sensing data according to the device cooperation cases for another type of means to replace the sensing data acquired through the existing training data collection device with the sensing data acquired through another type of means.

In step S10, the biological condition prediction unit 160 inputs the preprocessed sensing data to the prediction model M to enable the prediction model M to predict and output the biological conditions (i.e., at least one of the estrus index, the parturition index or the health index) corresponding to the sensing results of another type of means.

The foregoing description shows the handover of the training results based on two sensing devices to the prediction criteria for another type of device, but if necessary, the present disclosure may train the prediction model using one sensing device and transfer (handover) the training results to the prediction criteria for another type of device. That is, obviously, the implementation method of the present disclosure may be variously modified within the monitoring range of the biological conditions of pregnant breeding cattle with varying types and numbers of sensing devices.

While an exemplary embodiment of the present disclosure has been hereinabove illustrated and described, the present disclosure is not limited to the above-described particular embodiment, and various modifications may be made thereto by those skilled in the art without departing from the claimed subject matter of the present disclosure, and such modifications should not be individually understood from the technical spirit or scope of the present disclosure.

What is claimed is:

1. An apparatus for monitoring a biological condition of a pregnant breeding cattle, the apparatus comprising:
a training data collection unit configured to select and use at least two of an implantable device, a wearable device or an imaging device as a training data collection device to create multiple training data;
a prediction model training unit configured to pre-train a prediction model through the multiple training data;
a device cooperation cases setting unit configured to decide and store device cooperation cases by collecting and analyzing sensing data acquired through the training data collection devices;
a device cooperation conducting unit configured to preprocess the sensing data of a monitoring device according to the device cooperation cases when at least one of the training data collection devices is selected as the monitoring device; and
a biological condition prediction unit configured to predict and output a biological condition corresponding to the sensing data preprocessed through the prediction model,
wherein the prediction model has at least one of activity level, temperature, pressure, pulse, activity type, location information or Stage 1 rupture time point as an input condition and at least one of an estrus index, a parturition index or a health index as an output condition.

2. The apparatus of claim 1, wherein when data of a same item is redundantly acquired by the at least two training data collection devices, the training data collection unit acquires the data of the device having highest sensitivity to a condition change of the pregnant breeding cattle as an item representative value, and uses the acquired item representative value as the input condition of the train data.

3. The apparatus of claim 1, wherein in case that the implantable device and the wearable device are used as the training data collection device, and any one of the implantable device and the wearable device is used as the monitoring device, the device cooperation cases define activity level verification using a pulse sensor of the implantable device and an in vitro sensor of the wearable device, correction of a temperature change of the implantable device and an external sensor temperature change of the wearable device, correction of a pressure change of the implantable device and an external sensor pressure change of the wearable device, and detection and training of a change in activity level using a Stage 1 rupture time point value of the implantable device and the in vitro sensor of the wearable device.

4. The apparatus of claim 1, wherein in case that the implantable device and the imaging device are used as the training data collection device, and any one of the implantable device and the imaging device is used as the monitoring device, the device cooperation cases define activity level verification using a pulse sensor of the implantable device and the imaging device, detection and training of a change in activity level using a Stage 1 rupture time point value of the implantable device and the imaging device, and verification of labor and estrus behavior using the imaging device and a change of the in vivo sensor of the implantable device.

5. The apparatus of claim 1, wherein in case that the wearable device and the imaging device are used as the training data collection device, and any one of the wearable device and the imaging device is used as the monitoring device, the device cooperation cases define verification of labor and estrus behavior using the imaging device and a change of the in vitro sensor of the wearable device.

6. The apparatus of claim 1, wherein in case that the implantable device, the wearable device and the imaging device are used as the training data collection device, and at least one of the implantable device, the wearable device or the imaging device is used as the monitoring device, the device cooperation cases define correction of an actual behavior in the imaging device through an external sensor pressure change of the wearable device based on an in vivo pressure change of the implantable device, correction of accurate Stage 1 rupture time point of the wearable device through the Stage 1 rupture time point value of the implantable device and verification through the imaging device, verification of the labor and estrus behavior monitored by the imaging device and a change of the in vivo sensor of the implantable device and the in vitro sensor of the wearable device, correction of the activity level information of the in vivo activity sensor of the implantable device and the in vitro activity sensor of the wearable device and the activity type and activity level in an input image of the imaging device, data correction of the in vitro change of the wearable device based on the in vivo change of the implantable device and training of the imaging device with the activity type and activity level, correction of the imaging device with regard to the labor and estrus detected by the change of the in vivo sensor of the implantable device and the in vitro sensor of the wearable device and correction of the results, cross correction of the activity level of the in vivo activity sensor of the implantable device after activity level analysis and correction of the in vitro activity sensor of the wearable device and the imaging device, clustering correction of a candidate result group of analysis results of the in vitro change of the wearable device into the change of the in vivo sensor of the implantable device by analysis of a relationship with the activity level through the imaging device, training of the in vivo sensor change of the implantable device based on the in vitro sensor activity level information of the wearable device and the activity type verified by the imaging device, and training of the in vivo sensor change of the implantable device based on the in vitro sensor change of the wearable device and the labor and estrus detected by activity level analysis of the imaging device.

7. The apparatus of claim 1, wherein the device cooperation cases setting unit further includes a function to acquire sensing data based on another type of means which is any one of another type of device and another type of object, and additionally decide and store device cooperation cases for another type of means by comparative analysis with the sensing data acquired through the training data collection device.

8. The apparatus of claim 7, wherein the device cooperation conducting unit further includes a function to preprocess the sensing data of the monitoring device according to the device cooperation cases for another type of means in response to a biological condition monitoring request through any one of another type of device and another type of object.

9. An apparatus for monitoring a biological condition of pregnant breeding cattle, the apparatus comprising:
a training data collection unit configured to select and use at least one of an implantable device, a wearable device or an imaging device as a training data collection device to create multiple training data;
a prediction model training unit configured to pre-train a prediction model through the multiple training data;
a device cooperation cases setting unit configured to acquire sensing data based on another type of means which is any one of another type of device and another type of object, and decide and store device cooperation cases for another type of means by comparative analysis with the sensing data acquired through the training data collection device;
a device cooperation conducting unit configured to preprocess the sensing data of another type of device using the device cooperation cases for another type of means; and
a biological condition prediction unit configured to predict and output a biological condition corresponding to the sensing data preprocessed through the prediction model,
wherein the prediction model has at least one of activity level, temperature, pressure, pulse, activity type, location information or Stage 1 rupture time point as an input condition and at least one of an estrus index, a parturition index or a health index as an output condition.
